(19) United States
(12) Patent Application Publication
(10) Pub. No.: US 2026/0015511 A1
(43) Pub. Date: Jan. 15, 2026

(54) ELECTRODE SLURRY

(71) Applicant: ALLEGRO ENERGY PTY LTD, Thornton NSW (AU)

(72) Inventors: Fraser HUGHSON, Thornton NSW (AU); Rohan BORAH, Thornton NSW (AU); Thomas NANN, Thornton NSW (AU)

(21) Appl. No.: 18/996,513

(22) PCT Filed: Jul. 20, 2023
(86) PCT No.: PCT/AU2023/050664

§ 371 Date: Jan. 17, 2025

(30) Foreign Application Priority Data
Jul. 20, 2022 (AU) 2022902023

(51) Int. Cl. C09D 5/24; C08K 3/04; C08K 5/41; C09D 5/02; C09D 7/20; C09D 7/45; C09D 7/61; C09D 7/63; C09D 101/28; C09D 109/06; C09D 127/16; C09D 127/18; H01G 11/30; H01G 11/86; H01M 4/04; H01M 4/485; H01M 4/525; H01M 4/58; H01M 4/587; H01M 4/62; H01M 4/66; H01M 10/0525; H01M 10/054

(52) U.S. Cl. CPC C09D 5/24; C09D 5/022; C09D 5/027; C09D 5/028; C09D 7/20; C09D 7/45; C09D 7/61; C09D 7/63; C09D 101/286; C09D 109/06; C09D 127/16; C09D 127/18; H01G 11/30; H01G 11/86; H01M 4/0404; H01M 4/0409; H01M 4/485; H01M 4/525; H01M 4/5825; H01M 4/587; H01M 4/623; H01M 4/625; H01M 4/661; H01M 10/0525; H01M 10/054; C08K 3/04; C08K 5/41; C08K 2201/001

(57) ABSTRACT

The present disclosure generally relates to electrode slurry compositions, including those comprising an electrode active material; a binder; and a microemulsion comprising an aqueous phase, a water-immiscible phase, and an amphiphile, wherein the electrode active material and binder are incorporated within the microemulsion, which can be used to prepare electrodes, including for the production of electrochemical cells.

### FIELD

The present disclosure relates generally to electrode slurry compositions. In particular, the present disclosure relates to electrode slurry compositions which can be used to prepare electrodes, including for the production of electrochemical cells. The present disclosure also relates to processes for preparing electrode slurry compositions, and processes for preparing electrodes from electrode slurry compositions. The present disclosure also relates to the use of electrode slurry compositions for preparing electrodes for an electrochemical cell. The present disclosure also relates to electrochemical cells comprising electrodes prepared from the electrode slurry compositions.

### BACKGROUND

Energy consumption/production that rely on the combustion of fossil fuels is forecast to have a severe future impact on world economics and ecology. Electrochemical energy production is under serious consideration as an alternative energy/power source, as long as this energy consumption is designed to be more sustainable and more environmentally friendly (Winter et al., Chem. Rev. 2004, 104, 10, 4245-4270). Systems for electrochemical energy storage and conversion include electrochemical cells, such as batteries (e.g. lithium ion batteries), fuel cells, and supercapacitors. Although the energy storage and conversion mechanisms are different, there are “electrochemical similarities” across these electrochemical cells. Common features are that each require a positive and negative electrode, and the energy-providing processes take place at the phase boundary of the electrode/electrolyte interface and that electron and ion transport are separated.

One key step that is used almost universally in production of electrochemical cells, such as batteries (e.g. lithium ion batteries), fuel cells, and supercapacitors. is the preparation of electrodes by pasting of a slurry made of electrode active material, optional conductive agent, a binder, and a solvent onto a metallic current collector. This coated current collector is then passed through an oven at elevated temperature which removes the solvent and leaves behind a film of just the solid materials. Ideally this film is robust, uniform and has good adhesion to the metal.

The solvent typically used in industry is almost exclusively N-methyl pyrrolidone (NMP), and is used widely in industry and academic research for the reason that it gives the best results in terms of the desirable electrode properties described above. NMP is an expensive, moisture sensitive, environmentally hazardous organic solvent so finding a replacement for it is a high priority. It is industry practice to include NMP recovery systems into the production line that recaptures evaporated NMP to enable it to be recycled. Recovery of NMP is an energy intensive process and these systems are expensive. Accordingly, there is a need for alternative or improved electrode slurry compositions for use in the production electrodes and for electrodes used in electrochemical cells that can address one or more of the above problems and/or provide the public with a useful alternative.

It will be understood that any prior art publications referred to herein do not constitute an admission that any of these documents form part of the common general knowledge in the art, in Australia or in any other country.

### SUMMARY

The present disclosure provides particular electrode slurry compositions that can be used to prepare electrodes. The electrode slurry compositions described herein comprise an electrode active material and a microemulsion instead of NMP as the solvent. While water would be an ideal solvent to use, however this often leads to poor dispersibility of the solid materials and poor quality films that crack during drying. After extensive research and development, the present inventors have surprisingly discovered that microemulsions can be used in an electrode slurry composition to prepare high quality electrodes. Advantageously, the microemulsion replaces the expensive and hazardous NMP in the electrode slurry compositions to provide a cheaper and more environmentally friendly alternative. Furthermore, the physical and/or chemical properties of the microemulsion can be tailored to develop electrode slurry compositions specifically designed to produce high quality films for a given electrode active material, providing a versatile system for preparing a wide variety of electrodes.

In one aspect, there is provided an electrode slurry composition comprising: an electrode active material; a binder; and a microemulsion comprising an aqueous phase, a water-immiscible phase, and an amphiphile, wherein the electrode active material and binder are incorporated within a microemulsion.

In another aspect, there is provided a process for preparing the electrode slurry composition described herein, comprising mixing the microemulsion, active material and binder under conditions effective to form the electrode slurry composition.

In another aspect, there is provided a process for preparing an electrode, comprising the steps: coating a first surface of a current collector with the electrode slurry composition described herein; heating the electrode slurry composition at a temperature and for a period of time effective to dry the electrode slurry composition to form an electrode layer on the surface of the current collector, wherein the electrode layer comprises the electrode active material, conductive material and binder.

In another aspect, there is provided use of the electrode slurry composition described herein in preparing an electrode for an electrochemical cell.

In another aspect, there is provided an electrochemical cell comprising a positive electrode (e.g. a cathode), a negative electrode (e.g. an anode) and an electrolyte, wherein the positive and/or negative electrode is prepared using the electrode slurry composition described herein.

These and other aspects and embodiments relating to the present disclosure are further described herein. It will be appreciated that any one or more of the aspects, embodiments and examples described herein for the electrode slurry compositions may also apply to any one or more of the aspects, embodiments and examples of the process for preparing the electrode slurry compositions, process for preparing electrodes, uses of the electrode slurry compositions, electrodes and/or electrochemical cells described herein, and vice versa. Any embodiment, aspect or examples described herein shall be taken to apply mutatis mutandis to each and every other embodiment, aspect or example unless specifically stated otherwise. It will also be appreciated that other aspects, embodiments and examples of the electrode slurry compositions, processes, uses, electrodes, and/or electrochemical cells are described herein.

It will also be appreciated that some features of the electrode slurry compositions, processes, uses, electrodes, and/or electrochemical cells in some aspects, embodiments or examples as described herein may not be required in all aspects, embodiments or examples as described herein, and this specification is to be read in this context. It will also be appreciated that in the various aspects, embodiments or examples, the order of method or process steps may not be essential and may be varied.

### BRIEF DESCRIPTION OF DRAWINGS

Preferred embodiments of the present disclosure are further described and illustrated as follows, by way of example only, with reference to the accompanying drawings in which:

FIG. 1: Voltage-time graphs using electrodes prepared in Table 2.

FIG. 2: Voltage-time graphs using electrodes preparing in Table 3.

### DETAILED DESCRIPTION

The present disclosure describes the following various non-limiting embodiments, which relate to electrode slurry compositions that can be used in the production of electrodes and electrochemical cells. The electrode slurry compositions described herein comprise an electrode active material and microemulsion, which is further described below according to various non-limiting embodiments and examples. It has been surprisingly found that the electrode slurry compositions described herein provides one or more advantages including the preparation of high quality electrodes for electrochemical cells.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

### Terms

In the following description, reference is made to the accompanying drawings, which form a part hereof, and which is shown, by way of illustration, several embodiments. It is understood that other embodiments may be utilised and structural changes may be made without departing from the scope of the present disclosure.

With regards to the definitions provided herein, unless stated otherwise, or implicit from context, the defined terms and phrases include the provided meanings. Unless explicitly stated otherwise, or apparent from context, the terms and phrases below do not exclude the meaning that the term or phrase has acquired by a person skilled in the relevant art. The definitions are provided to aid in describing particular embodiments, and are not intended to limit the claimed disclosure, because the scope of the disclosure is limited only by the claims. Furthermore, unless otherwise required by context, singular terms shall include pluralities and plural terms shall include the singular.

All publications discussed and/or referenced herein are incorporated herein in their entirety.

Any discussion of documents, acts, materials, devices, articles or the like, which has been included in the present specification is solely for the purpose of providing a context for the present disclosure. It is not to be taken as an admission that any or all of these matters form part of the prior art base or were common general knowledge in the field relevant to the present disclosure as it existed before the priority date of each claim of this application.

Throughout this disclosure, unless specifically stated otherwise or the context requires otherwise, reference to a single step, composition of matter, group of steps or group of compositions of matter shall be taken to encompass one and a plurality (i.e., one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

The person skilled in the art will appreciate that the disclosure herein is susceptible to variations and modifications other than those specifically described. It is to be understood that the disclosure includes all such variations and modifications. The disclosure also includes all of the examples, steps, features, methods, compositions, coatings, processes, and coated substrates, referred to or indicated in this specification, individually or collectively, and any and all combinations or any two or more of said steps or features.

The term “and/or”, e.g., “X and/or Y” shall be understood to mean either “X and Y” or “X or Y” and shall be taken to provide explicit support for both meanings or for either meaning.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

As used herein, the term “about”, unless stated to the contrary, typically refers to +/−10%, for example +/−5%, of the designated value.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

Throughout the present specification, various aspects and components of the disclosure can be presented in a range format. The range format is included for convenience and should not be interpreted as an inflexible limitation on the scope of the disclosure. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 2, 3, 4, 4.5 and 5, unless where integers are required or implicit from context. This applies regardless of the breadth of the disclosed range. Where specific values are required, these will be indicated in the specification.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The reference to “substantially free” generally refers to the absence of that compound or component in the composition other than any trace amounts or impurities that may be present, for example this may be an amount by weight % in the total composition of less than about 1%, 0.1%, 0.01%, 0.001%, or 0.0001%.

The term “immiscible”, with reference to two or more materials, means that a material will not dissolve or combine with another material. With reference to immiscible liquids in biphasic systems such as the microemulsions described herein, “immiscible” means that the liquids are insoluble with each other, or are so sparingly soluble in each other that for all practical purposes the liquids are conventionally considered to be insoluble with each other. When two immiscible liquids are combined in a system, it will form a biphasic system of immiscible liquids.

The terms “water” and “oil” (e.g. as used in reference to oil in water microemulsions and water in oil microemulsions) are understood to represent the aqueous phase and the water-immiscible phase. The term “water-immiscible phase” is used to describe any liquid that is immiscible with the aqueous phase. “Water phase” and “aqueous phase”, as used herein, may be used interchangeably.

The term “slurry” refers to a liquid mixture comprising solid particles.

### Electrode Slurry Compositions

The present disclosure covers various research and development directed to identifying electrode slurry compositions, which can be used in the preparation of electrodes, including those used for an electrochemical cell. The electrode slurry compositions of the present disclosure comprise an electrode active material; a binder; and a microemulsion comprising an aqueous phase, a water-immiscible phase, and an amphiphile, wherein the electrode active material, binder are incorporated within the microemulsion. According to some embodiments or examples, the microemulsion and/or electrode slurry composition is substantially free of N-methyl-2-pyrrolidone (NMP).

One or more advantages of the present disclosure according to at least some embodiments or examples as described herein is that the microemulsion can replace the expensive and hazardous NMP in the electrode slurry compositions providing a cheaper and more environmentally friendly system for preparing high quality electrodes. The physical and/or chemical properties of the microemulsion can be tailored to develop electrode slurry compositions specifically designed to produce high quality films for a given electrode active material, providing a versatile system for preparing a wide variety of electrodes.

Owing to the presence of at least the electrode active material, binder and optional conductive material incorporated (e.g. dissolved/suspended/interspersed) within the microemulsion, the slurry has a solids content. In one embodiment, the slurry has a solids content (% w/w) of at least about 1, 2, 3, 4, 5, 6, 7, 8, 9, 10, 20, 30, 40, 50, 60, 70, 80 or 90 based on the total weight of the slurry. In one embodiment, the slurry has a solids content (% w/w) of less than about 90, 80, 70, 60, 50, 40, 30, 20, 10, 9, 8, 7, 6, 5, 4, 3, 2 or 1 based on the total weight of the slurry. The solids content may be a range provided by any two of these upper and/or lower values, for example the slurry may have a solids content (% w/w) of between about 1 to about 90, between about 10 to about 90, between about 20 to about 60, between about 30 to about 50, between about 1 to about 50, or between about 1 to about 10 based on the total weight of the slurry.

While any amount of electrode active material can be used to prepare the slurries described herein, in one embodiment, the slurry comprises between about 25% w/w to about 90% w/w electrode active material based on the total weight of the solids incorporated within the microemulsion. The slurry may comprise at least about 25, 50, 55, 60, 65, 70, 75, 80, 85 or 90% w/w electrode active material based on the total weight of the solids incorporated within the microemulsion. The slurry may comprise less than about 90, 85, 80, 75, 70, 65, 60, 55, 50 or 25% w/w electrode active material based on the total weight of the solids incorporated within the microemulsion. The % w/w of electrode active material based on the total weight of the solids incorporated within the microemulsion may be a range provided by any two of these upper and/or lower values, for example the slurry may comprise between about 50% w/w to about 90% w/w, or between about 80% w/w to about 90% w/w electrode active material based on the total weight of the solids incorporated within the microemulsion. While any amount of binder can be used to prepare the slurries described herein, in one embodiment, the slurry comprises between about 1% w/w to about 20% w/w binder based on the total weight of the solids incorporated within the microemulsion. The slurry may comprise at least about 1, 2, 4, 6, 8, 10, 12, 14, 16, 18 or 20% w/w binder based on the total weight of the solids incorporated within the microemulsion. The slurry may comprise less than about 20, 18, 16, 14, 12, 10, 8, 6, 4, 2 or 1% w/w binder based on the total weight of the solids incorporated within the microemulsion. The % w/w of binder based on the total weight of the solids incorporated within the microemulsion may be a range provided by any two of these upper and/or lower values, for example the slurry may comprise between about 1% w/w to about 10% w/w binder based on the total weight of the solids incorporated within the microemulsion.

If present, while any amount of conductive material can be used to prepare the slurries described herein, in one embodiment, the slurry comprises between about 1% w/w to about 30% w/w conductive material based on the total weight of the solids incorporated within the microemulsion. The slurry may comprise at least about 1, 2, 4, 6, 8, 10, 12, 14, 16, 18, 20, 25 or 30% w/w conductive material based on the total weight of the solids incorporated within the microemulsion. The slurry may comprise less than about 30, 25, 20, 18, 16, 14, 12, 10, 8, 6, 4, 2 or 1% w/w conductive material based on the total weight of the solids incorporated within the microemulsion. The % w/w of conductive material based on the total weight of the solids incorporated within the microemulsion may be a range provided by any two of these upper and/or lower values, for example the slurry may comprise between about 5% w/w to about 20% w/w conductive material based on the total weight of the solids incorporated within the microemulsion.

### Microemulsions

The electrode slurry composition comprises a microemulsion. The electrode active material, binder, and other optional additives such as a conductive agent, are incorporated within the microemulsion. As used herein, the term “incorporated” generally refers to the microemulsions ability to act as a suitable carrier for the one or more recited components. For example, the electrode active material may be interspersed within the microemulsion (e.g. suspended) as a solid particulate. The binder, depending on its properties, may be dissolved within the microemulsion (e.g. dissolved in the aqueous phase and/or water immiscible phase of the microemulsion). Nonetheless, dissolved or suspended components within the microemulsion are understood to be “incorporated” as used herein.

As used herein, the term “microemulsion” refers to a thermodynamically stable mixture of two immiscible liquid phases. Microemulsions can be “oil-in-water” (O/W), “water-in-oil” (W/O), or “bicontinuous”; these terms which define a microemulsion structure are well known in the art. In oil-in-water microemulsions, a water-immiscible phase is dispersed in a continuous aqueous phase. In water-in-oil microemulsions, an aqueous phase is dispersed in a continuous water-immiscible phase. In bicontinuous microemulsions, an aqueous phase and a water-immiscible phase are each interconnected and interspersed throughout the mixture. Typically, microemulsions have a micro-heterogeneous liquid biphasic structure, which, at the macroscopic level, appears homogenous. The aqueous and water-immiscible phases of the microemulsion are immiscible at the desired operating temperature (which is usually at or around room temperature). Microemulsions are thermodynamically stable, and therefore are able to form spontaneously (without application of energy), and do not separate out into their constituent phases over time once formed.

It should be emphasised that ‘emulsions’ are very different to microemulsions, despite similar nomenclature. Emulsions are thermodynamically unstable (kinetically stable) mixtures of immiscible liquids. This means that, in contrast to microemulsions, the two immiscible phases of an emulsion will separate out over time. Unlike surfactant free microemulsions which exist, emulsions of immiscible liquids almost always require the presence of a stabilising agent to prevent phase separation, particularly surfactants or viscosity modifiers. For example, viscosity modifiers (e.g. thickeners such as polysaccharides) have previously been used to stabilise emulsions by slowing droplet coalescence as the immiscible phases separate, which has led to such viscosity modifiers being called emulsifiers or stabilisers even though they are not surfactants/amphiphilic as understood in the art. Such highly viscous and thick emulsions may be more stable but are often difficult to evenly disperse electrode active material and binder throughout, and once these components are incorporated, the overall slurry may be of such high viscosity owing to the thickening agent that it is difficult to blade coat onto a current collector resulting in an uneven non-uniform electrode layer leading to decreased performance.

The microemulsion comprises an aqueous phase and a water-immiscible phase. In one embodiment, the microemulsion is an oil-in-water (O/W) microemulsion (i.e. the water-immiscible phase is dispersed in the aqueous phase, and the aqueous phase is a continuous phase). In an alternative embodiment, the microemulsion is a bicontinuous microemulsion (i.e. the water-immiscible phase and the aqueous phase are bicontinuous). In yet another embodiment, the microemulsion is a water-in-oil (W/O) microemulsion (i.e. the water-immiscible phase is a continuous phase and the aqueous phase is a dispersed phase). The type of microemulsion (e.g. O/W, W/O or bicontinuous) may depend on the properties of the electrode active material and be tailored to develop electrode slurry compositions specifically designed to produce high quality films for a given electrode active material. According to some embodiments or examples, it has been found that electrode slurry compositions comprising an oil-in-water (O/W) microemulsion can be used to prepare high quality electrodes as demonstrated in the Examples.

Solvents used as the water-immiscible phase of the microemulsion may include a water-immiscible solvent or a combination of two or more water-immiscible solvents. In one embodiment, the water-immiscible phase comprises an organic solvent (e.g. a water-immiscible organic solvent). By way of example only, a non-limiting list of solvents that are suitable to be used as the water-immiscible phase of the microemulsion include aliphatic solvents (e.g. cyclic and non-cyclic, branched and non-branched alkanes, such as hexane, cyclohexane and petroleum ether, alkenes, alkynes); aromatic solvents (e.g. benzene, toluene, p-xylene, 1,2-dichlorobenzene); halogenated solvents (e.g. dichloromethane, chloroform, dichloroethane); ether solvents (e.g. diethyl ether, diphenylether); ketone solvents (e.g. acetophenone); ester solvents (e.g. ethyl benzoate, ethyl acetate); or a combination thereof.

In one embodiment, the organic solvent is selected from the group consisting of aliphatic solvents; aromatic solvents; halogenated solvents; substantially water immiscible ketone solvents; substantially water immiscible ether solvents; substantially water immiscible ester solvents, or a combination thereof.

In one embodiment, organic solvent is selected from the group consisting of hexane, cyclohexane, petroleum ether, benzene, toluene, p-xylene, 1,2-dichlorobenzene, dichloromethane, chloroform, dichloroethane, ethyl acetate, and diethyl ether, or a combination thereof.

In some embodiments, the organic solvent has a boiling point of less than about 150° C., which is near the boiling point of water (being the preferred component of the aqueous phase) and comparatively lower than other higher boiling point long chain compounds used to prepare emulsions. In some embodiments, the organic solvent has a boiling point (in ° C.) of between about 20 to about 150.

In some embodiments, the water-immiscible phase and water miscible phase has a boiling point differential of between about 1° C. to about 100° C. (that is the difference between the boiling points of each phase). For example, if the water miscible phase is water (boiling point of about 100° C.) and the water-immiscible phase is toluene (boiling point of about 110° C.), then the boiling point differential is about 10° C. In some examples, the boiling point differential (in ° C.) between the water-immiscible phase and water miscible phase is between about 1 to about 100, 1 to about 80, 10 to about 70,

In some examples, by preparing a microemulsion using a water-immiscible phase with boiling point near to or lower than the boiling point of water, which is a preferred component of the aqueous phase, provides further advantages such as the formation of a uniform electrode coating due to lower heat required during the drying step described herein. In some preferred cases, the organic solvent as the water immiscible phase may have a boiling point similar to or lower than that of water, which is a preferred component of the aqueous phase.

According to some embodiments or examples described herein, organic solvents having relatively low boiling points together with a suitable aqueous phase such as water, allows for the electrode slurry once coated on a surface of a current collector to be heated a relatively low temperatures and yet still be effectively dried thereby forming a uniform electrode layer on the surface of the current collector. In particular, the inventors of the present application have surprisingly discovered that utilising such low boiling point organic solvents as the water-immiscible phase, lower drying temperatures (e.g. less than about 200° C.) can provide for a more uniform electrode. In contrast, water-immiscible phases comprising longer chain higher alkanes, carboxylic acids or fatty acids for example, have substantially higher boiling points as compared to water (e.g. boiling points of greater than 300° C.) which means the temperature required to dry an electrode slurry comprising these longer chain compounds is much higher and can impact on the integrity of the electrode, and as such does not result in the more uniform electrode obtained at lower drying temperatures. Additionally, water-immiscible and water-immiscible phases having similar boiling points means that the microemulsion composition remains similar throughout the drying process (e.g. no one phase is predominantly removed before another), as opposed to emulsions comprising phases having very different boiling points, such as water and long chain carboxylic acids, where water would be removed first leaving being the long chain carboxylic acid which takes longer to remove (if at all), and may impact how the electrode evolves as it dries. Having a slurry where the microemulsion phases dry off at approximately the same rate (owing to similar boiling points) would keep the formation of the electrode layer happening under the same conditions throughout drying rather than going through a stepwise drying regime (i.e. water removing regime followed by a significantly higher boiling point phase removing regime). In one embodiment, the concentration of the water-immiscible phase (% w/w) is at least about 1, 5, 10, 15, 20, 25, 30, 35, 40, 45, 50, 55, 60, 65, 70, 75, 80, 85, 90, 95 or 99 based on the total weight of the microemulsion. In one embodiment, the concentration of the water-immiscible phase (% w/w) is less than about 99, 95, 90, 85, 80, 75, 70, 65, 60, 55, 50, 45, 40, 35, 30, 25, 20, 15, 10, 5 or 1 based on the total weight of the microemulsion. The % w/w concentration of the water-immiscible phase in the microemulsion may be a range provided by any two of these upper and/or lower values, for example the concentration of the water-immiscible phase (% w/w) may be between about 5 to about 95, between about 25 to about 75 or between about 40 to about 60 based on the total weight of the microemulsion. It will be appreciated that the concentration of water-immiscible phase will vary depending on the type of microemulsion. For example, a O/W microemulsion will comprise less water-immiscible phase compared to a W/O emulsion.

In embodiments where the microemulsion is a O/W microemulsion, the concentration of the water-immiscible phase (% w/w) may be between about 1 to about 60, between about 1 to about 50, between about 1 to about 40, or between about 1 to about 20 based on the total weight of the microemulsion.

In embodiments where the microemulsion is a bicontinuous microemulsion, the concentration of the water-immiscible phase (% w/w) may be between about 20 to about 80 based on the total weight of the microemulsion.

In embodiments where the microemulsion is a W/O microemulsion, the concentration of the water-immiscible phase (% w/w) may be between about 40 to about 99, between about 50 to about 99, between about 60 to about 99, or between about 80 to about 99 based on the total weight of the microemulsion.

In one embodiment, the aqueous phase comprises water. In another embodiment, the aqueous phase comprises a water-miscible solvent. In one embodiment, the aqueous phase comprises a mixture of water and a water-miscible solvent. The water-miscible solvent may be an alcohol, for example methanol, ethanol, propanol or pentanol, or a mixture thereof. It will be appreciated that the aqueous phase of the microemulsion electrolyte composition must be immiscible with the water-immiscible phase.

In one embodiment, the concentration of the aqueous phase (% w/w) is at least about 5, 10, 15, 20, 25, 30, 35, 40, 45, 50, 55, 60, 65, 70, 75, 80, 85, 90, 95 or 99 based on the total weight of the microemulsion. In one embodiment, the concentration of the aqueous phase (% w/w) is less than about 99, 95, 90, 85, 80, 75, 70, 65, 60, 55, 50, 45, 40, 35, 30, 25, 20, 15, 10 or 5 based on the total weight of the microemulsion. The % w/w concentration of the aqueous phase in the microemulsion may be a range provided by any two of these upper and/or lower values, for example the concentration of the aqueous phase (% w/w) may be between about 5 to about 95, between about 25 to about 75 or between about 40 to about 60. It will be appreciated that the concentration of the aqueous phase will vary depending on the type of microemulsion. For example, a O/W microemulsion will comprise more aqueous phase compared to a W/O emulsion.

In embodiments where the microemulsion is a O/W microemulsion, the concentration of the aqueous phase (% w/w) may be between about 40 to about 99, between about 50 to about 99, between about 60 to about 99, or between about 80 to about 99 based on the total weight of the microemulsion.

In embodiments where the microemulsion is a bicontinuous microemulsion, the concentration of the aqueous phase (% w/w) may be between about 20 to about 80, based on the total weight of the microemulsion.

In embodiments where the microemulsion is a W/O microemulsion, the concentration of the aqueous phase (% w/w) may be between about 1 to about 60, between about 1 to about 50, between about 1 to about 40, or between about 1 to about 20 based on the total weight of the microemulsion.

The relative proportions of the aqueous phase and the water-immiscible phase in the microemulsion are naturally limited by the overall thermodynamic stability of the mixture of components that make up the microemulsion (e.g. aqueous phase, water-immiscible phase). There are natural limitations on the relative proportions of each phase in which it is thermodynamically favourable for the composition to exist as a microemulsion. There are further natural limitations on the relative proportions of each phase to achieve an oil-in-water microemulsion or a bicontinuous microemulsion. The relative proportions of each phase may be determined theoretically, or by routine experimentation by a person skilled in the art. It will also be appreciated that the relative proportions of the aqueous phase and water-immiscible phase include any and all proportions and ranges thereof in which a microemulsion is formed. As oil-in-water and bicontinuous microemulsion systems are preferred, the preferred proportions of the aqueous phase and water immiscible phase are those that yield oil-in-water and bicontinuous microemulsions.

The microemulsion further comprises one or more amphiphiles. As understood in the art, an amphiphile is a molecule having both hydrophobic and hydrophilic regions which stabilizes the microemulsions. Suitable amphiphiles are described herein and a selection of amphiphiles are used in the Examples, but the disclosure is not limited to these specific compounds. As will be appreciated by the person skilled in the art, the choice of amphiphile is dependent on the type of microemulsion desired (e.g. O/W. W/O or bicontinuous), and/or the chemical nature and composition of the microemulsion or components thereof, and/or on the specific identities and proportions of the components in the electrode slurry composition. In some cases, a suitable phase diagram of the target microemulsion can assist in identifying the appropriate amounts of the phases and/or the type/amount of amphiphile to be used.

The amphiphile may be a surfactant, co-surfactant or a co-solvent. In one embodiment, the microemulsion further comprises a surfactant. As understood in the art, the surfactant is a chemical compound that can decreases the surface or interfacial tension between the water-miscible and water-immiscible phases of the microemulsion, owing to the presence of both hydrophobic and hydrophilic regions.

In one embodiment, the microemulsion further comprises a co-solvent. The co-solvent is often completely or at least partially miscible with each of the phases of the microemulsion leading to improved phase stability.

Suitable surfactants, co-surfactants and co-solvents that can be used as the amphiphile(s) for the preparation of microemulsion will be known to the person skilled in the art. Examples of suitable surfactants include anionic surfactants, cationic surfactants, zwitterionic surfactants and non-ionic surfactants. Examples of preferred surfactants include Triton X-100, cetyltrimethyl ammonium bromide (CTAB), cetyltrimethylammonium chloride (CTAC), cetylpyridinium chloride (CPC), benzalkonium chloride, benzethonium chloride, sodium dodecyl sulfate (SDS), and sodium lauryl ether sulfate (SLES). Examples of suitable co-surfactants or co-solvents include aliphatic alcohols, such as C₂-C₆ alcohols, amines, such as C₂-C₆ alkyl amines, and short chain carboxylic acids (C₂-C₆). Preferred co-surfactants and/or co-solvents for the present disclosure include ethanol, propanol, butanol and pentanol. As will be appreciated by the person skilled in the art, the choice of amphiphile is dependent on the type of microemulsion desired (oil-in-water, bicontinuous or water-in-oil), and on the specific identities and proportions of the components in the electrode slurry composition (e.g. the electrode active material, binder, optional conductive material etc.).

A factor for determining preferred relative proportions of the aqueous phase and water-immiscible phase is an aim of achieving the required incorporation of the electrode active material, binder material and, if present, the conductive material in the microemulsion.

From the foregoing description, it will be clear that the amounts of each component in the microemulsion (e.g. aqueous phase, water-immiscible phase, and amphiphiles etc.) may be configured or adjusted to optimise parameters such that it is possible to customise microemulsions, in terms of their physical and chemical properties, so that a microemulsion can be developed that is specifically designed to achieve the required incorporation of the electrode active material, binder material and, if present, the conductive material in the microemulsion. This customisability is advantageous as it can allow to high quality films of a variety of materials to be produced. Such optimisations would be a matter of routine experimentation and are within the scope of this disclosure.

The microemulsion may be prepared according to known methods of preparing microemulsions that are familiar to the person skilled in the art. The microemulsions of the present disclosure may be prepared by the combination of the individual components. As microemulsions are thermodynamically stable, they are able to form spontaneously. However, agitation of the microemulsion components may be performed so that the microemulsion forms in a suitably short amount of time. For example, the combined components may be agitated by stirring, shaking or sonication.

The microemulsion may be prepared in ambient conditions, that is, at room temperature and in the presence of ambient moisture, oxygen, carbon dioxide and other atmospheric constituents.

In one embodiment, the concentration of microemulsion (% w/w) is at least about 5, 10, 15, 20, 25, 30, 35, 40, 45, 50, 55, 60, 65, 70, 75, 80, 85, 90, 95 or 99 based on the total weight of the electrode slurry composition. In one embodiment, the concentration of microemulsion (% w/w) is less than about 99, 95, 90, 85, 80, 75, 70, 65, 60, 55, 50, 45, 40, 35, 30, 25, 20, 15, 10 or 5 based on the total weight of the electrode slurry composition. The % w/w concentration of microemulsion in the electrode slurry composition may be a range provided by any two of these upper and/or lower values, for example the concentration of microemulsion (% w/w) may be between about 5 to about 99, between about 10 to about 90, between about 40 to about 80, between about 50 to about 70, between about 50 to about 99, between about 60 to about 99, between about 70 to about 99, between 80 to about 99, or between about 90 to about 99, based on the total weight of the electrode slurry composition.

### Electrode Active Material

The electrode slurry composition comprises an electrode active material, which is incorporated (e.g. interspersed) within the microemulsion. The electrode active material may be any electrochemically active species that can be used as an electrode (e.g. positive or negative electrode such as a cathode or anode) in an electrochemical cell. The electrode active material may be selected from any known in the art. In one embodiment, the electrode active material comprises positive electrode material (e.g. cathode material). In one embodiment, the electrode active material comprises negative electrode material (e.g. anode material).

In one embodiment, the electrode active material may be selected from the group consisting of a transition metal oxide or mixed-metal oxide (e.g. lithium cobalt oxide, sodium metatitanate, lithium titanate, vanadium pentoxide), a transition metal salt which includes transition metal phosphates and sulfates (e.g. lithium iron phosphate, sodium iron sulfate), vanadates (e.g. ammonium meta-vanadate), elemental (e.g. sulfur), main group nitrides (e.g. boron nitride), main group oxides (e.g. boron anhydride), perylenes and other organics (e.g. 3,4,9,10-perylenetetracarboxyanhydride), Prussian Blue an analogues thereof (e.g. iron (III) ferricyanide), and carbon-based material (e.g. carbon black, graphite and activated carbon). However, it will be appreciated that the electrode slurry compositions can comprise essentially any electrode active material, and represents a versatile system for preparing a wide range of electrodes.

In one embodiment, the concentration of electrode active material (% w/w) is at least about 1, 2, 4, 5, 10, 15, 20, 25, 30, 35, 40, 45, 50, 55, 60, 65, 70, 75, 80, 85, 90 or 95 based on the total weight of the electrode slurry composition. In one embodiment, the concentration of electrode active material (% w/w) is less than about 95, 90, 85, 80, 75, 70, 65, 60, 55, 50, 45, 40, 35, 30, 25, 20, 15, 10, 5, 4, 2 or 1 based on the total weight of the electrode slurry composition. The % w/w concentration of electrode active material in the electrode slurry composition may be a range provided by any two of these upper and/or lower values, for example the concentration of electrode active material (% w/w) may be between about 1 to about 90, between about 8 to about 60, between about 10 to about 50, between about 1 to about 50, between about 1 to about 20, or between about 1 to about 10 based on the total weight of the electrode slurry composition.

### Binder

The electrode slurry compositions comprise a binder, which is incorporated (e.g. dissolved) within the microemulsion. The binder holds the electro active material together and assists in adhering the electrode active material to the current collector. According to some embodiments or examples described herein, introducing the binder into the microemulsion allows the electrode coating to begin directly from slurry formation, and requires a single drying step which both removes the microemulsion and solidifies the binder and adheres the electrode active material to the current collector, providing a straightforward process to prepare the electrode layer

The binder may be selected from any known in the art. In one embodiment, the binder is a polymeric binder. In one embodiment, the binder is selected from the group consisting of polyvinylidene difluoride (PVDF), polytetrafluoroethylene (PTFE), sodium carboxy methyl cellulose (CMC), styrene butadiene rubber (SBR), or a combination thereof (e.g. a mixture of SBR and CMC).

In one embodiment, the concentration of binder (% w/w) is at least about 0.01, 0.05, 0.1, 0.2, 0.5, 1, 2, 5, 10, 12, 14, 16, 18, 20 or 30 based on the total weight of the electrode slurry composition. In one embodiment, the concentration of binder (% w/w) is less than about 30, 20, 18, 16, 14, 12, 10, 5, 2, 1, 0.5, 0.2, 0.1, 0.05 or 0.01 based on the total weight of the electrode slurry composition. The % w/w concentration of binder in the electrode slurry composition may be a range provided by any two of these upper and/or lower values, for example the concentration of binder (% w/w) may be between about 0.1 to about 30, 0.2 to about 30, between about 0.5 to about 20, between about 0.7 to about 15, between about 0.1 to about 20, between about 0.1 to about 10, between about 0.1 to about 5, or between 0.1 to about 1, based on the total weight of the electrode slurry composition.

In one embodiment, the binder is dissolved in the aqueous phase or water-immiscible phase of the microemulsion. The advantage of having a microemulsion based slurry system is that the binder can be dissolved in either the aqueous phase or water-immiscible phase. This allows for a wide range of possible binders and binder amount to be used. For example, binders having different solubility properties can be used without having to change the whole solvent system of the slurry given it is soluble in at least one of the phases of the microemulsion.

### Conductive Material

The electrode slurry compositions may further comprise a conductive material, which if present is incorporated (e.g. interspersed) within the microemulsion. Typically, the conductive material is added to improve the resulting electrodes charge and discharge performance by forming a percolating network for electron transport in the electrode which largely improves the electrode conductivity. However, where the electrode active material is also conductive (e.g. graphite), the conductive material may not be required.

The conductive material may be selected from any known in the art. In one embodiment, the conductive material is a carbon based material. In a further embodiment, the conductive material is carbon black. Carbon black can come in various varieties, such as “super-P” or “Ketjen black 600JD”. Carbon black is particularly useful for improving the conductivity of the electrodes and decreasing the resistance of interaction. In another embodiment the conductive material is graphite.

In one embodiment, the concentration of conductive material (% w/w) is at least about 0.01, 0.05, 0.1, 0.2, 0.5, 1, 2, 5, 10, 12, 14, 16, 18, 20 or 30 based on the total weight of the electrode slurry composition. In one embodiment, the concentration of conductive material (% w/w) is less than about 30, 20, 18, 16, 14, 12, 10, 5, 2, 1, 0.5, 0.2, 0.1, 0.05 or 0.01 based on the total weight of the electrode slurry composition. The % w/w concentration of conductive material in the electrode slurry composition may be a range provided by any two of these upper and/or lower values, for example the concentration of conductive material (% w/w) may be between about 0.2 to about 30, between about 0.5 to about 20, between about 0.7 to about 15, between 0.1 to about 30, between about 0.1 to about 10, between about 0.1 to about 5, or between about 0.1 to about 2 based on the total weight of the electrode slurry composition.

### Additives

The electrode slurry composition may further comprise one or more additional additives. The additives may be added as a component of the microemulsion or as a separate component.

In one embodiment, the microemulsion may further comprise a dissolved salt. The dissolved salts may be selected from the group including Group 1 salts, Group 2 salts, transition metal salts, aluminium salts, or a combination thereof. Examples of dissolved salts include but are not limited to LiCl, NaCl, KCl, LiOH, NaOH, KOH, MgSO₄, MgCl₂, Zn(NO₃)₂, and AlCl₃. The aqueous phase may comprise the dissolved salt. The aqueous phase may also include dissolved Group 1 ions, Group 2 ions, transition metal ions, aluminium ions, or a combination thereof. Examples of dissolved ions include lithium, sodium, potassium, magnesium, aluminium, calcium, chromium, manganese, iron, cobalt, copper, nickel, zinc, silver, halogen ions (e.g. fluorides, chlorides, chlorates, bromides, bromates, iodides, iodates), sulfate ions, nitrate ions, and a combination thereof. The concentration of dissolved salt or ions in the aqueous phase may be between 0% and a saturated aqueous solution. Exemplary ranges of dissolved salt or ions include between 0 and 10 M, more preferably between about 0.01M and 5 M, more preferably between 0.05 M and 1 M, most preferably between about 0.05 M and 0.5 M.

In one embodiment, the salts are added to the microemulsion once it is already formed, or may be added to the aqueous component prior to preparation of the microemulsion. In one embodiment, the salts are added to the aqueous component prior to preparation of the microemulsion.

### Process for Preparing Electrode Slurry Compositions

In a further aspect of the present disclosure, there is provided a process for preparing the electrode slurry composition. The process for preparing an electrode slurry composition comprises mixing the microemulsion, electrode active material, binder and, if present, conductive agent, and mixing under conditions effective to form the electrode slurry composition.

The microemulsion, binder, electrode active material and, if present, conductive material may be mixed at any suitable temperature effective to form the slurry. For example, the mixing may be at a temperature (° C.) of at least about 10, 15, 20, 25, 30, 35, 40, 45 or 50. The mixing may be at a temperature (° C.) of less than about 50, 45, 40, 35, 30, 25, 20, 15 or 10. The mixing temperature may be a range provided by any two of these upper and/or lower values, for example the microemulsion, electrode active material, binder and, if present, conductive agent may be mixed at a temperature (° C.) of between about 10 to about 50.

The microemulsion, binder, electrode active material and, if present, conductive material may be mixed at for a period of time effective to form the slurry. For example, the mixing may be for a period of time (minutes) of at least about 5, 10, 15, 20, 30, 60 or 120. The mixing may be for a period of time (minutes) of less than about 120, 60, 30, 20, 15, 10 or 5. The mixing time may be a range provided by any two of these upper and/or lower values, for example the microemulsion, electrode active material, binder and, if present, conductive agent may be mixed for a period of time (minutes) of between about 5 to 120.

In one embodiment, the microemulsion, electrode active material, binder and, if present, conductive agent is mixed for a period of time effective to form a homogenous dispersion of the electrode active material, binder and, if present, conductive agent within the microemulsion.

In one embodiment, the process comprises adding the microemulsion to the electrode active material, binder and, if present, conductive agent, and mixing under conditions effective to form the electrode slurry composition. In an alternative embodiment, the process comprises dissolving/suspending the binder in the microemulsion which is then added to the electrode active material and, if present, conductive agent, and mixing under conditions effective to form the electrode slurry composition.

The mixing may be employed using any suitable method, for example magnetic stirring, planetary mixing, or mixing by hand. Alternatively or additionally, the slurry can be mixed under vacuum, or placed under vacuum after preparation. By doing so, further advantages are provided such as removing any dissolved gasses present in the slurry (i.e. degassing). In one embodiment, the process comprises degassing the slurry.

### Electrodes

The present disclosure also provides an electrode prepared using the electrode slurry composition described herein.

In one aspect, there is provided a process for preparing an electrode comprising the steps:
coating a first surface of a current collector with an electrode slurry composition comprising: an electrode active material; binder; optionally a conductive material; and a microemulsion comprising an aqueous phase and a water-immiscible phase, wherein the electrode active material, binder and, if present conductive material, are incorporated within the microemulsion; and
heating the electrode slurry composition at a temperature and for a period of time effective to dry the electrode slurry composition to form an electrode layer on the surface of the current collector wherein the electrode layer comprises the electrode active material, binder and, if present, conductive agent.

The electrode can be used as a positive electrode (e.g. cathode) and/or a negative electrode (e.g. an anode).

The electrode slurry composition can be applied to the first surface of the current collector by any suitable method. In one embodiment, the electrode slurry composition is coated onto the first surface of the current collector by transfer coating, slot-die coating, doctor blading, dip coating, screen printing, spray coating or brush coating. The coating is typically performed at ambient temperature. The coating can be performed one or more times if required to obtain an electrode slurry coating layer of a suitable thickness. In one embodiment, the electrode slurry composition is applied to the first surface of the current collector to provide an electrode slurry coating having a thickness (μm) of at least about 1, 2, 5, 10, 20, 50, 100, 200, 500, 1000, 5000, or 10,000. In one embodiment, the electrode slurry composition is applied to the first surface of the current collector to provide an electrode slurry coating having a thickness (μm). The thickness of the electrode slurry coating may be a range provided by any two of these upper and/or lower values, for example between about 1 μm to about 1 mm, preferably between about 50 μm to about 200 μm.

The electrode slurry composition and current collector are typically heated together (e.g. by placing the coated current collector in an oven). The electrode slurry composition may be heated at a temperature and for a period of time effective to form the electrode layer. This may include a temperature effective to solidify the binder and/or dry off and remove the microemulsion. The heating step may substantially remove at least the aqueous phase of the microemulsion (i.e. substantially removes water). In one embodiment, the electrode layer is substantially free of water.

In one embodiment, the electrode slurry composition is heated at a temperature (° C.) of at least about 50, 70, 100, 110, 130, 150, 180 or 200. In one embodiment, the electrode slurry composition is heated at a temperature (° C.) of less than about 200, 180, 150, 130, 110, 70 or 50. The heating temperature may be a range provided by any two of these upper and/or lower values, for example between about 50 to about 200, or between about 100 to about 150. Lower temperatures such as these may provide for a more uniform electrode. It will be appreciated that the duration of the heating will depend on the temperature, with lower temperatures requiring longer heating times and higher temperatures requiring shorter heating times. In one embodiment, the electrode slurry composition is heated for a period of time (hours) of at least about 0.1, 0.5, 1, 2, 4, 6, 9, 12, 18, 24 or 48. In one embodiment, the electrode slurry composition is heated for a period of time (hours) of less than about 48, 24, 18, 12, 9, 6, 4, 2, 1, 0.5 or 0.1. The heating time may be a range provided by any two of these upper and/or lower values, for example between about 0.1 to about 48 hours, or between about 6 to about 48 hours. In one embodiment, the slurry may be heated under vacuum.

It will be appreciated that the electrode may be provided in any shape, size, thickness or configuration. The electrode may be provided in a range of thicknesses depending on the application. The thickness of the electrode may be controlled, in part, by the thickness of the electrode slurry coating.

The amount of slurry coating the first surface of the current collector can vary depending on the overall target thickness of the electrode layer. In one embodiment, the electrode layer has a thickness (μm) of at least about 1, 2, 5, 10, 20, 50, 100, 200, 500, 1000, 5000, or 10,000. In one embodiment the electrode layer has a thickness (in μm) of less than about 10,000, 5000, 1000, 500, 200, 100, 50, 20, 10, 5, 2 or 1. The thickness of the electrode layer may be a range provided by any two of these upper and/or lower values, for example between about 1 μm to about 1 mm, preferably between about 50 μm to about 200 μm.

In one embodiment, in the process for preparing an electrode the electrode layer and current collector are compressed at a pressure effective to increase the density of the electrode layer and/or promote contact between the surface of the current collector and the electrode layer. The electrode layer and current collector may be compressed at a pressure (MPa) of at least about 0.1, 1, 2, 5, 10, 20, 40, 60, 80 or 100. The electrode layer and current collector may be compressed at a pressure (MPa) of less than about 100, 80, 60, 40, 20, 10, 5, 2, 1 or 0.1. The compression pressure may be a range provided by any two of these upper and/or lower values, for example the pressure (MPa) may be between about 0.1 to about 100.

The current collector may be any suitable current collector used to prepare electrodes. The current collector may have a morphology and/or properties effective to support the electrode slurry composition. In one embodiment, the current collector is a metal (e.g. steel) or carbon based (e.g. graphite) current collector. In one embodiment, the current collector comprises aluminium or copper current collector. In one embodiment, the current collector comprises aluminium or copper. In one embodiment, the current collector is in the form of a foil.

The current collector may have any suitable thickness. In one embodiment, the current collector has a thickness of between about 10 μm to about 1000 μm. The current collector may have a thickness (in μm) of at least about 10, 20, 50, 70, 100, 120, 150, 200, 250, 300, 350, 400, 500, 600, 800 or 1000. The current collector may have a thickness (in μm) of less than about 1000, 800, 600, 500, 400, 350, 300, 250, 200, 150, 120, 100, 70, 50, 20 or 10. The thickness may be a range provided by any two of these upper and/or lower values, for example between about 50 μm to about 500 μm.

The current collector may have a roughened or textured surface which may provide an enhanced surface area which can facilitate interspersion, incorporation or embedding of the electrode layer on or within the current collector. It will be appreciated that such surface roughening or texturing is understood to mean that the surface of the current collector has been manipulated (i.e. roughened or textured) and does not encompass native “dead-flat” or polished surface which may have some form of microscopic roughness. In other words, the surface roughening is achieved by some physical or mechanical processing of the substrates surface, for example via abrading. The current collector may be initially a sheet, which is subsequently cut to an appropriate size after the electrode layer has been formed on the surface of the current collector to form an electrode capable of being incorporated into an electrochemical cell.

In some embodiments, at least about 50, 60, 70, 80, 90, 95 or 98% of a surface of the current collector is covered with the electrode slurry composition/electrode layer.

In one embodiment, the process further comprises forming an electrochemical cell using the electrode.

### Electrochemical Cells

In a further aspect of the present disclosure, there is provided an electrochemical cell. It will be appreciated that an electrochemical cell comprises a positive electrode (e.g. a cathode) and a negative electrode (e.g. an anode) in fluidic communication with an electrolyte. The positive and/or negative electrode may be prepared using the electrode slurry composition described herein.

In one aspect, there is provided an electrochemical cell comprising: a positive electrode (e.g. cathode), a negative electrode (e.g. an anode) and an electrolyte, wherein the anode and/or cathode is prepared using the electrode slurry composition and process described herein. For example, the positive electrode and/or negative electrode may comprise a current collector coated with an electrode layer prepared using the electrode slurry composition described herein.

The electrochemical cell may be suitable for any type of battery. For example, the electrochemical cell may be an ion battery or a flow battery. In one embodiment, the electrochemical cell is a lithium ion battery, a magnesium ion battery, a sodium ion battery, an aluminium ion battery, or a supercapacitor.

In an embodiment, the electrochemical cell may be an ion battery, or a flow battery. Preferably, the electrochemical cell may be a lithium ion battery, a magnesium ion battery, a sodium ion battery, an aluminium ion battery, or a redox flow battery.

The electrochemical cell may be prepared using the electrodes described herein in accordance with known methods. For example, a typical battery comprises a battery case of any suitable shape, standard or otherwise, which is made from an appropriate material for containing the electrolyte, such as aluminium or steel, and usually not plastic; battery terminals of a typical configuration; a positive electrode; a negative electrode; a separator for separating the positive electrode from the negative electrode; and an electrolyte.

The electrode comprises a current collector. At least one of the positive and/or negative electrode comprises an electrode layer on the current collector, which has been prepared using the electrode slurry composition described herein.

Ion batteries, such as lithium ion batteries, may be constructed in ambient conditions using at least one electrode prepared by the process described herein. For example, a first electrode comprising an electrode layer on the surface of a current collector is placed into a body (e.g. a plastic cell) with the electrode layer facing the interior. Glass microfiber filters are cut to size and then placed on top of the first electrode to act as a separator. For small batteries, between about 0.1 mL to about 1 mL of suitable electrolyte is added on top of the glass microfiber before a second electrode comprising an electrode layer on the surface of a current collector is placed in the cell with the electrode layer facing the interior of the cell. The components are secured and the cell is closed, for example by screwing the cell closed.

Usually the battery will be in the form of a single cell, although multiple cells are possible. The cell or cells may be in plate or spiral form, or any other form. The positive and negative electrode are in electrical connection with the battery terminals.

The electrolyte may be any suitable electrolyte known to the skilled person, and may be selected depending on the type of electrochemical cell being developed. In one embodiment, the electrolyte comprises or consists of a microemulsion as described herein. Microemulsion electrolytes are also disclosed in PCT/NZ2019/050164, the contents of which are incorporated by reference. Alternatively, the electrolyte may comprise water, an organic solvent, or a mixture thereof. In one embodiment, the electrolyte may comprise water or one or more solvents selected from water, ethers, esters, carbonates, and acetals. In one example, the one or more electrolyte solvents are selected from 1,2-dimethoxyethane, diglyme, triglyme, tetraglyme, ethylene carbonate, propylene carbonate, dimethyl carbonate, tetrahydrofuran, acetonitrile, and dioxolane, or mixtures thereof.

In one aspect, there is provided use of the electrode slurry composition described herein in preparing an electrode for an electrochemical cell. In another aspect, there is provided an electrode slurry composition described herein for use in preparing an electrochemical cell.

The present application claims priority from AU2022902023 filed on 20 Jul. 2022, the entire contents of which are incorporated herein by reference.

### EXAMPLES

The present disclosure is further described by the following examples. It is to be understood that the following description is for the purpose of describing particular embodiments only and is not intended to be limiting with respect to the above description.

### Example 1: Microemulsions

Microemulsion samples were prepared according to the following method. Each microemulsion sample comprised an aqueous component and a water-immiscible component, optionally a co-solvent, optionally a surfactant and/or optionally a co-surfactant. The components of each microemulsion sample are shown in Table 1.

The surfactant was weighed into an Erlenmeyer flask to which the water-immiscible component and co-surfactant were added. This mixture was stirred thoroughly to form a uniform slurry, and the aqueous component was then added. The mixture was turbid and white, which upon sonication in an ultrasonic bath or stirring, led to the formation of a clear microemulsion.

ME2 and ME2i was prepared according to the method described in Menger, F. M. & Elrington, A. R. “Organic reactivity in microemulsion systems” J. Am. Chem. Soc. 113, 9621-9624 (1991), and the methods of preparing ME2i was based on this disclosure. ME4 was prepared according to the method described in Mukherjee, K., Mukherjee, D. C. & Moulik, S. P. “Thermodynamics of Microemulsion Formation” J. Colloid Interface Sci. 187, 327-333 (1997). ME14a and ME14b was prepared according to the method described in Gorel, F. “Assessment of agar gel loaded with microemulsion for the cleaning of porous surfaces” CeROArt Conserv. Expo. Restaur. D'Objets D'Art (2010).

For the microemulsions with dissolved salts, the required amount of salt was weighed and added to the prepared microemulsion.

TABLE 1
Microemulsion compositions used in
the electrode slurry compositions

| | ME2i | ME4 | ME14a | ME14b |
|---|---|---|---|---|
| Water | 60 | 82 | 72.07 | 65.52 |
| Toluene | 15 | — | | |
| Cyclohexane | — | — | 1.33 | 10.3 |
| n-butanol | 16.67 | 10 | | |
| Hexane | — | 3 | | |
| SDS | 8.33 | — | | |
| Triton X-100 | — | — | 26.6 | 24.18 |
| CTAB | — | 5 | | |

### Example 2: Electrode Slurry Preparation

First, 300 mg of the dry slurry components were weighed out and added to a dry sample vial. Then the microemulsion is added to the same vial along with a magnetic stir bar. The resulting slurry is left stirring vigorously until the desired consistency has been reached and all material is suitably dispersed. This is all done under ambient conditions. The % w/w of electrode active material, conductive carbon and binder making up the total 300 mg of dry slurry component, and the mL volume of microemulsion used to prepare the slurry is outlined in Tables 2 to 5.

### Example 3: Electrode Fabrication

The slurry is then coated onto graphite foil with a blade coater (MSK-AFA-HC100, MTI Corp.) to a wet film thickness of 200 microns. This is done with the aid of a mask. The coated film is then placed into an extractor oven (UT20P, Heraeus Instruments) at 80° C. for 2 hours, and then a vacuum oven (AI, PRDC3000, MTI Corp.) at 180° C. for 12 hours. Electrodes of appropriate size are then cut out from the larger sheet and weighed to establish the mass of electrode slurry on the electrode. These electrodes are then stored until necessary or used immediately.

### Example 4: Test Cell Fabrication

All prepared cells were Swagelok-type cells. First an electrode is placed onto the glassy carbon current collector inside the cell casing with the active material facing the interior of the cell. Then, 1 or 2 glass microfiber (Whatman, GF-D) separators, that have been cut to size, are placed on top of the first electrode, within the cell casing. Then the appropriate electrolyte is added, usually between 1 and 2 ml. The final electrode is then placed on top of the glass separator, with the active material facing into the interior of the cell. The second current collector is then paced on top of the second electrode and the full cell is compressed to ensure good contacts and sealed shut.

### Example 5: Electrode Performance

Assembled cells were attached to a battery analyser capable of performing “galvanostatic charge discharge” experiments (Neware BTS4000 Series 5V12A). The positive lead was attached to the positive electrode and the negative lead was attached to the negative electrode. The cells were cycled 10 times at 500 milliamps per gram of electrode material (MW1, MW2), and 100 milliamps per gram of electrode material (MW3) The results were then analysed for suitable performance. The performance of the test cells comprising the fabricated electrodes is summarised in Tables 2 to 5.

TABLE 2
Electrode slurry compositions used in making film and film testing data.

| | Active | Conductive | | | Vol. | ME as | | Current | Passed GCDC |
|---|---|---|---|---|---|---|---|---|---|
| | material | carbon | Binder | ME as | solvent | electrolyte | Voltage | applied | test? Y/N/ |
| Version | (% w/w) | (% w/w) | (% w/w) | solvent | ME (mL) | in cell | range | (mA) | Untested |
| MW1-1 | Activated | Ketjen | PVDF | ME2i | 7.2 | ME2i | 0-2.5 V | 0.5 | Y |
| MW1-2 | carbon | black | (6.9%) | ME4 | | | | | Y |
| MW1-3 | (82.76%) | (10.34%) | | ME14 | | | | | Y |
| MW1-4 | | | | ME14a | | | | | Y |
| MW1-5 | | | | ME14b | | | | | Y |
| MW1-6 | | | | ME2i + 0.1M NaCl | | | | | Y |
| MW1-7 | Activated | Ketjen | PTFE | ME2i | 3.6 | | | | Y |
| MW1-8 | carbon | black | (10%) | ME4 | | | | | Y |
| MW1-9 | (80%) | (10%) | | ME14 | | | | | Y |
| MW1-10 | | | | ME14a | | | | | Y |
| MW1-11 | | | | ME14b | | | | | Y |
| MW1-12 | | | | ME2i + 0.1M NaCl | | | | | Y |

TABLE 3
Film composition, microemulsion used in making film and film testing data.

| | | | | | Vol. | ME as | | Current | Passed |
|---|---|---|---|---|---|---|---|---|---|
| | Active | Conductive carbon | Binder | ME as | solvent | electrolyte | Voltage | applied | GCDC |
| Version | material (% w/w) | (% w/w) | (% w/w) | solvent | ME (mL) | in cell | range | (mA) | test? |
| MW2-1 | Activated carbon | Super P (10.34%) | PVDF (6.9%) | ME2i | 7.2 | ME2i | 0-2.5 V | 0.5 | Y |
| MW2-2 | (82.76%) | | | ME4 (CTAB) | | | | | Y |
| MW2-3 | | | | ME14a | | | | | Y |
| MW2-4 | | Ketjen black | CMC (6.9%) | ME2i | | | | | Y |
| MW2-5 | | (10.34%) | | ME4 (CTAB) | | | | | Y |
| MW2-6 | Activated carbon (80%) | Ketjen black (10%) | CMC (10%) | ME14a | 3.6 | | | | Y |
| MW2-7 | Activated carbon | Ketjen black | SBR (6.9%) | ME2i | 7.2 | | | | Y |
| MW2-8 | (82.76%) | (10.34%) | | ME4 (CTAB) | | | | | Y |
| MW2-9 | | | | ME14a | | | | | Y |
| MW2-10 | Activated carbon | Ketjen black | — | ME2i | 3.6 | | | | Y |
| MW2-11 | (88.89%) | (11.11%) | | ME4 (CTAB) | | | | | Y |
| MW2-12 | | | | ME14a | | | | | Y |
| MW2-13 | Activated carbon | Ketjen black | CMC (3.45%)/ | ME2i | 7.2 | | | | Y |
| MW2-14 | (82.76%) | (10.34%) | SBR (3.45%) | ME4 (CTAB) | | | | | Y |
| MW2-15 | Activated carbon (80%) | Ketjen black (10%) | CMC (5%)/ | ME14a | 3.6 | | | | Y |
| | | | SBR (5%) | | | | | | |

TABLE 4
Film composition, microemulsion used in making film and film testing data.

| | | Conductive | | | Vol. | | | Current | Passed |
|---|---|---|---|---|---|---|---|---|---|
| | | carbon | Binder | ME as | solvent | ME as | Voltage | applied | GCDC |
| Version | Active material (% w/w) | (% w/w) | (% w/w) | solvent | ME (mL) | electrolyte in cell | range | (mA) | test? |
| MW3-A | Anode: Lithium Titanate (80%) | Ketjen | PVDF | ME14a | 7.2 | ME14 + 0.1 mol/kg | 0-2 V | 0.1 | Y |
| | Cathode: Lithium cobalt oxide (80%) | Black (10%) | (10%) | | | Li2SO4 + 10 wt % | | | |
| MW3-B | Anode: Lithium Titanate (80%) | Ketjen | PVDF | | | Diglyme | | | Y |
| | Cathode: Lithium iron phosphate (80%) | Black (10%) | (10%) | | | | | | |
| MW3-C | Anode: Lithium Titanate (80%) | Ketjen | PVDF | | | | | | Y |
| | Cathode: Boron nitride (80%) | Black (10%) | (10%) | | | | | | |
| MW3-D | Anode: Lithium Titanate (80%) | Ketjen | PVDF | | | | | | Y |
| | Cathode: Boric anhydride (%) | Black (10%) | (10%) | | | | | | |
| MW3-E | Anode: Lithium Titanate (80%) | Ketjen | PVDF | | | | | | Y |
| | Cathode: Ammonium metavanadate (80%) | Black (10%) | (10%) | | | | | | |
| MW3-F | Anode: Lithium Titanate (80%) | Ketjen | PVDF | | | | | | Y |
| | Cathode: Vanadium oxide (80%) | Black (10%) | (10%) | | | | | | |
| MW3-G | Anode: Lithium Titanate (80%) | Ketjen | PVDF | | | | | | Y |
| | Cathode: Sulfur (80%) | Black (10%) | (10%) | | | | | | |
| MW3-H | Anode: Graphite (80%) | Ketjen | PVDF | | | | | | Y |
| | Cathode: Vanadium oxide (80%) | Black (10%) | (10%) | | | | | | |
| MW3-I | Anode: Sodium metatitanate (80%) | Ketjen | PVDF | | | ME14 + 0.1 mol/kg | | | Y |
| | Cathode: Sodium iron sulphate (80%) | Black (10%) | (10%) | | | NaCl + 10 wt % | | | |
| MW3-J | Anode: Sodium metatitanate (80%) | Ketjen | PVDF | | | Diglyme | | | Y |
| | Cathode: Iron(III) ferricyanide (80%) | Black (10%) | (10%) | | | | | | |
| MW3-K | Anode: Sodium metatitanate (80%) | Ketjen | PVDF | | | | | | Y |
| | Cathode: PTCDA (80%) | Black (10%) | (10%) | | | | | | |
| MW3-L | Anode: Lithium Titanate (80%) | Ketjen | PVDF | | | ME14 + 0.1 mol/kg | | | Y |
| | Cathode: PTCDA (80%) | Black (10%) | (10%) | | | MgCl2 + 10 wt % | | | |
| | | | | | | Diglyme | | | |

TABLE 5
Film composition, microemulsion used in making film and film testing data.

| | | Conductive | | | Vol. | ME as | | | Passed |
|---|---|---|---|---|---|---|---|---|---|
| | Active | carbon | Binder | ME as | solvent | electrolyte | Voltage | Current | GCDC test? |
| Version | material (% w/w) | (% w/w) | (% w/w) | solvent | ME (mL) | in cell | range | applied (mA) | Y/N/Untested |
| MW3-1 | Lithium cobalt | Ketjen | PVDF | ME2i | 7.2 | — | — | — | Untested |
| MW3-2 | oxide (83.6%) | Black (10.4%) | (6%) | ME4 (CTAB) | | | | | |
| MW3-4 | Sodium | Ketjen | PVDF | ME2i | | | | | |
| MW3-5 | metatitanate (83.6%) | Black (10.4%) | (6%) | ME4 (CTAB) | | | | | |
| MW3-7 | Lithium iron | Ketjen | PVDF | ME2i | | | | | |
| MW3-8 | phosphate (83.6%) | Black (10.4%) | (6%) | ME4 (CTAB) | | | | | |
| MW3-10 | Graphite (83.6%) | Ketjen | PVDF | ME2i | | | | | |
| MW3-11 | | Black (10.4%) | (6%) | ME4 (CTAB) | | | | | |
| MW3-13 | Iron(III) | Ketjen | PVDF | ME2i | | | | | |
| MW3-14 | ferricyanide (83.6%) | Black (10.4%) | (6%) | ME4 (CTAB) | | | | | |
| MW3-16 | PTCDA (83.6%) | Ketjen | PVDF | ME2i | | | | | |
| MW3-17 | | Black (10.4%) | (6%) | ME4 (CTAB) | | | | | |
| MW3-19 | Lithium titanate | Ketjen | PVDF | ME2i | | | | | |
| MW3-20 | (83.6%) | Black (10.4%) | (6%) | ME4 (CTAB) | | | | | |
| MW3-22 | Vanadium oxide | Ketjen | PVDF | ME2i | | | | | |
| MW3-23 | (83.6%) | Black (10.4%) | (6%) | ME4 (CTAB) | | | | | |
| MW3-25 | Boron nitride | Ketjen | PVDF | ME2i | | | | | |
| MW3-26 | (83.6%) | Black (10.4%) | (6%) | ME4 (CTAB) | | | | | |
| MW3-28 | Boric anhydride | Ketjen | PVDF | ME2i | | | | | |
| MW3-29 | (83.6%) | Black (10.4%) | (6%) | ME4 (CTAB) | | | | | |
| MW3-31 | Ammonium | Ketjen | PVDF | ME2i | | | | | |
| MW3-32 | metavanadate (83.6%) | Black (10.4%) | (6%) | ME4 (CTAB) | | | | | |
| MW3-34 | Sodium iron | Ketjen | PVDF | ME2i | | | | | |
| MW3-35 | sulphate (83.6%) | Black (10.4%) | (6%) | ME4 (CTAB) | | | | | |
| MW3-37 | Sulfur (83.6%) | Ketjen | PVDF | ME2i | | | | | |
| MW3-38 | | Black (10.4%) | (6%) | ME4 (CTAB) | | | | | |

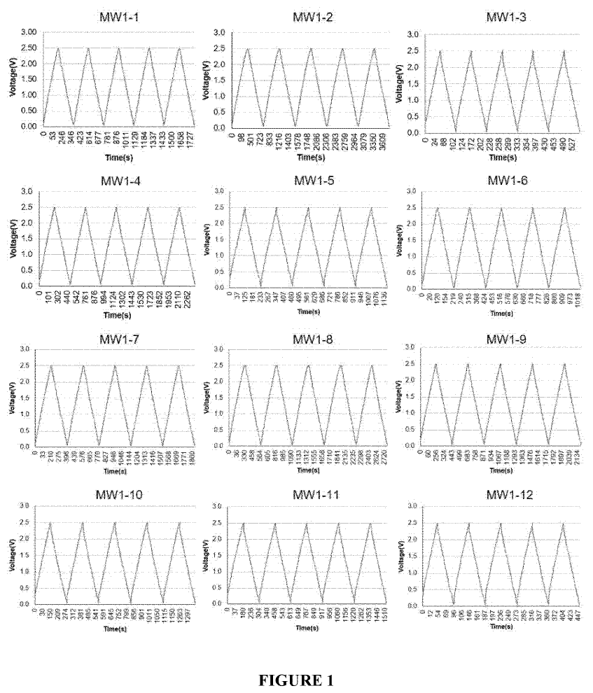

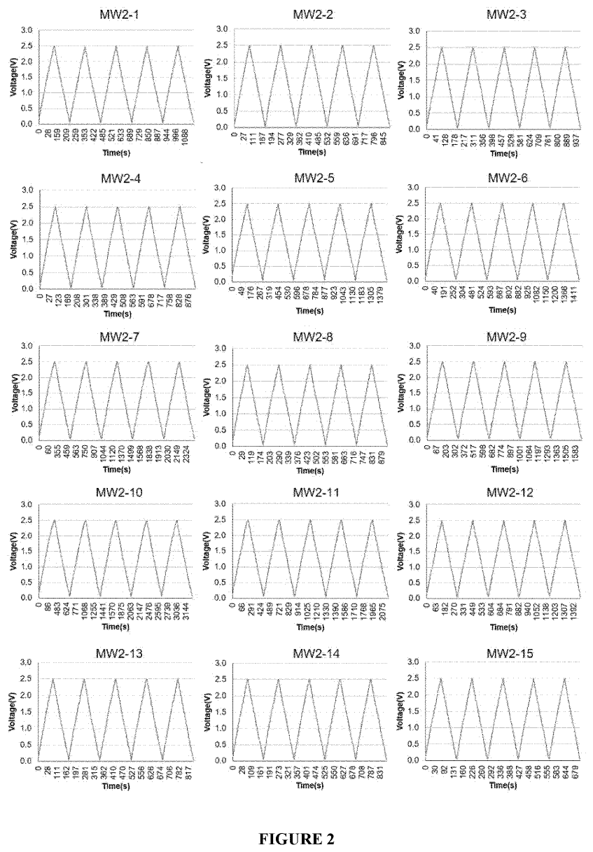

Referring to FIGS. 1 and 2, the voltage vs time graphs demonstrate that test cells comprising the fabricated electrodes are stable, and are able to be repeatedly charged to a voltage of 2.5 V with no visible signs of degradation, which if present would be observed as long irregular plateaus at or near the maximum voltages. The lack of any visible degradation highlights the fabricated electrodes stability. Additionally, the time taken for the charge-discharge cycles is constant over the test time period, also highlighting the electrodes stability. A low quality electrode would degrade and would reduce in capacity rapidly, leading to shorter cycles over time.

1. An electrode slurry composition comprising:
an electrode active material;
a binder; and
a microemulsion comprising an aqueous phase, a water-immiscible phase, and an amphiphile,
wherein the electrode active material and binder are incorporated within the microemulsion.

2. The electrode slurry composition of claim 1, wherein the electrode slurry composition further comprises a conductive material.

3. The electrode slurry composition of claim 1 or claim 2, wherein the microemulsion is substantially free of N-methyl-2-pyrrolidone (NMP).

4. The electrode slurry composition of any one of claims 1 to 3, wherein the electrode slurry has a solids content (% w/w) of between about 1 to about 90, between about 1 to about 50, or between about 1 to about 10, based on the total weight of the slurry.

5. The electrode slurry composition of any one of claims 1 to 4, wherein the microemulsion is an oil-in-water (O/W) microemulsion, a water-in-oil (W/O) microemulsion, or a bicontinuous microemulsion.

6. The electrode slurry composition of any one of claims 1 to 5, wherein the aqueous phase is water.

7. The electrode slurry composition of any one of claims 1 to 6, wherein the water-immiscible phase comprises an organic solvent.

8. The electrode slurry composition of any one of claims 1 to 7, wherein the organic solvent is selected from the group consisting of aliphatic solvents; aromatic solvents; halogenated solvents; substantially water immiscible ketone solvents; substantially water immiscible ether solvents; substantially water immiscible ester solvents; or a combination thereof.

9. The electrode slurry composition of any one any one of claims 1 to 8, wherein the organic solvent is selected from the group consisting of hexane, cyclohexane, petroleum ether, benzene, toluene, p-xylene, 1,2-dichlorobenzene, dichloromethane, chloroform, dichloroethane, ethyl acetate, and diethyl ether, or a combination thereof.

10. The electrode slurry composition of any one of claims 1 to 9, wherein the water-immiscible phase and water miscible phase has a boiling point differential between about 1° C. to about 100° C.

11. The electrode slurry composition of claim 10, wherein the amphiphile is a surfactant or a co-solvent, or a mixture thereof.

12. The electrode slurry composition of any one of claims 1 to 11, wherein the surfactant is a cationic surfactant, an anionic surfactant, a zwitterionic surfactant, or a non-ionic surfactant.

13. The electrode slurry composition of any one of claims 1 to 12, wherein the surfactant is selected from the group consisting of Triton X-100, cetyltrimethyl ammonium bromide (CTAB), cetyltrimethylammonium chloride (CTAC), cetylpyridinium chloride (CPC), benzalkonium chloride, benzethonium chloride, sodium dodecyl sulfate (SDS), and sodium lauryl ether sulfate (SLES).

14. The electrode slurry composition of claim 13, wherein the co-solvent is an alcohol, an amine or a short chain carboxylic acid.

15. The electrode slurry composition of claim 13 or claim 14, wherein the co-solvent is selected from the group consisting of ethanol, propanol, butanol and pentanol

16. The electrode slurry composition of any one of claims 1 to 15, wherein the microemulsion further comprises a dissolved salt, preferably selected from the group consisting of a lithium salt, a sodium salt, a potassium salt, a magnesium salt, a calcium salt, and an aluminum salt.

17. The electrode slurry composition of any one of claims 1 to 16, wherein the amount of electrode active material in the electrode slurry composition (% w/w) is between about 1 to about 90, between about 1 to about 50, between about 1 to about 20 or between about 1 to about 10 based on the total weight of the slurry.

18. The electrode slurry composition of any one of claims 1 to 17, wherein the electrode active material comprises positive electrode material (e.g. cathode material).

19. The electrode slurry composition of any one of claims 1 to 18, wherein the electrode active material comprises negative electrode material (e.g. anode material).

20. The electrode slurry composition of any one claims 1 to 19, wherein the electrode active material is selected from the group consisting of a transition metal oxide or mixed-metal oxide, a transition metal salt, vanadates, elemental, main group nitrides, main group oxides, perylenes and other organics, Prussian Blue an analogues thereof, and carbon-based material.

21. The electrode slurry composition of any one of claims 1 to 20, wherein the amount of binder in the electrode slurry composition (% w/w) is between about 0.1 to about 30, between about 0.1 to about 20, between about 0.1 to about 10, or between 0.1 to about 5, based on the total weight of the electrode slurry composition.

22. The electrode slurry composition of any one claims 1 to 21, wherein the binder is dissolved in the aqueous phase or water-immiscible phase.

23. The electrode slurry composition of any one claims 1 to 22, wherein the binder is selected from the group consisting of polyvinylidene difluoride, polytetrafluoroethylene, sodium carboxy methyl cellulose, styrene butadiene rubber, or a mixture of styrene-butadiene rubber and carboxymethyl cellulose, or a combination thereof.

24. The electrode slurry composition of any one claims 1 to 23, wherein the amount of conductive material in the electrode slurry (% w/w) is between about 0.1 to about 30, between about 0.1 to about 10, or between about 0.1 to about 5 based on the total weight of the electrode slurry composition.

25. The electrode slurry composition of any one claims 2 to 24, wherein the conductive material is a carbon based conductive material.

26. The electrode slurry composition of claim 25, wherein the carbon based conductive material is carbon black or a derivative thereof, or graphene, or a combination thereof.

27. A process for preparing an electrode slurry composition of any one of claims 1 to 26, comprising mixing the microemulsion, electrode active material, binder and, if present, conductive agent under conditions effective to form the electrode slurry composition.

28. The process for preparing an electrode slurry composition of claim 27, wherein the microemulsion, electrode active material, binder and, if present, conductive agent are mixed at a temperature of between about 10° C. to about 50° C.

29. The process for preparing an electrode slurry composition of claim 27 or claim 28, wherein the microemulsion, electrode active material, binder and, if present, conductive agent are mixed for a period of time effective to form a homogenous dispersion of the electrode active material, binder and, if present, conductive agent within the microemulsion.

30. The process for preparing an electrode slurry composition of any one of claims 27 to 29, wherein the microemulsion, electrode active material, binder and, if present, conductive agent are mixed for a period of time of between about 5 min to about 120 min.

31. A process for preparing an electrode, comprising the steps:
coating a first surface of a current collector with an electrode slurry composition of any one of claims 1 to 26;
heating the electrode slurry composition at a temperature and for a period of time effective to dry the electrode slurry composition to form an electrode layer on the surface of the current collector,
wherein the electrode layer comprises the electrode active material, binder, and, if present, conductive material.

32. The process for preparing an electrode of claim 31, wherein the electrode layer has a thickness of between about 1 μm to about 1 mm, preferably between about 50 μm to about 200 μm.

33. The process for preparing an electrode of claim 31 or claim 32, wherein the electrode layer is substantially free of water.

34. The process for preparing an electrode of any one of claims 31 to 33, wherein the electrode slurry composition is coated onto the first surface of the current collector by transfer coating, slot-die coating, doctor blading, dip coating, screen printing, spray coating or brush coating.

35. The process for preparing an electrode of any one of claims 31 to 34, wherein the electrode slurry composition is heated at a temperature of between about 50° C. to 200° C.

36. The process for preparing an electrode of any one of claims 31 to 35, wherein the electrode slurry composition is heated for a period of time (hours) of between about 0.1 to about 48 hours.

37. The process for preparing an electrode of any one of claims 31 to 36, wherein the electrode layer and current collector are compressed at a pressure effective to increase the density of the electrode layer and/or promote contact between the surface of the current collector and the electrode layer.

38. The process for preparing an electrode of any one of claims 31 to 37, wherein the electrode layer and current collector are compressed at a pressure of between about 0.1 MPa to about 100 MPa.

39. The process for preparing an electrode of any one of claims 31 to 38, wherein the current collector is a metal or carbon based current collector.

40. The process for preparing an electrode of any one of claims 31 to 39, wherein the metal based current collector comprises aluminium or copper.

41. The process for preparing an electrode of any one of claims 31 to 40, wherein the carbon based current collector comprises graphite or graphene.

42. The process for preparing an electrode of any one of claims 31 to 41, wherein the current collector is in the form of a foil.

43. The process for preparing an electrode of any one of claims 31 to 42, wherein the electrode is a positive electrode (e.g. cathode).

44. The process for preparing an electrode of any one of claims 31 to 43, wherein the electrode is a negative electrode (e.g. anode).

45. Use of the electrode slurry composition of 1 to 26 in preparing an electrode for an electrochemical cell.

46. An electrochemical cell comprising a cathode, an anode and an electrolyte, wherein the positive and/or negative electrode is prepared using the process of 31 to 44.

47. The electrochemical cell of claim 46, wherein the electrochemical cell is a lithium ion battery, a magnesium ion battery, a sodium ion battery, an aluminium ion battery, or a supercapacitor.
